(19) United States
(12) Patent Application Publication
(10) Pub. No.: US 2010/0215188 A1
(43) Pub. Date: Aug. 26, 2010

(54) Vehicle Mounted Cradle and Sound Amplifier for a Personal Communication Device

(76) Inventor: Clinton Wilcox, Grass Valley, CA (US)

Correspondence Address: MATHEW J. TEMMERMAN, 423 E STREET, DAVIS, CA, 95616, US

(21) Appl. No.: 12/632,972

(22) Filed: Dec. 8, 2009

Related U.S. Application Data
(60) Provisional application No. 61/154,700, filed on Feb. 23, 2009.

(51) Int. Cl. H04B 1/00; H04R 1/02

(52) U.S. Cl. 381/86

(57) ABSTRACT

The present invention is a vehicle mounted cradle and sound amplifier for a personal communication device, the cradle and amplifier comprising a microphone, amplifier, flat panel speaker, power source, and power saving means. A personal communication device used in conjunction with the cradle and sound amplifier is secured and oriented such that a control interface of the communication device faces towards a vehicle driver's seat. A microphone placed in close proximity to the speaker on a common communication device detects sound emitted from the communication device. A flat panel speaker then amplifies that sound for the user of the communication device to hear. A power saving means is disclosed for regulating power from said power source, the power saving means including an audio-level based lower-power standby mode. The cradle amplifies the communication device while minimizing audio feedback. Further, because the amplifier is only supplied power when the communication device is inserted, it exhibits excellent battery life. Finally, the simplicity of the device increases reliability during its use, decreases the cost of manufacturing, and makes the safety of hands free mobile phone use more greatly accessible to the public.

### BACKGROUND

1. Field of the Invention

The present invention is related to cradles for personal communication devices, and more specifically to a vehicle mounted sound amplifying cradle for a personal communication device.

2. Description of Related Art

Due to their convenience and increasingly to the law that mobile phone or personal communication device users utilize “hands free” systems while driving, the popularity of such “hands free” systems is increasing. While dubbed “hands free” such systems generally require limited physical input by the user, such as to activate the device, answer a call, or to dial out. Vehicle mounted hands free systems often take this fact into account and commonly employ the use of a cradle or other mounting device to position the personal communication device within easy access of the user/driver. Exemplary holders include those affixed to the dashboard, windshield, or even cup holder such as that described by US Pat. Pub. 2007/0036352 (“Portable Accessory Holder”). By positioning the phone in one of these locations, the driver of the vehicle can quickly activate the device as needed while being only mildly distracted from the act of driving.

Many of the above devices merely secure the personal communication device and do not amplify the device sound in any way. This is reflected in the fact that most mobile telephones include a loudspeaker in anticipation of hands free use. Some cradles and phone holders have the capability to amplify sound from the personal communication device attached thereto. This is primarily due to concerns regarding the volume limit of the personal communication device—itself a result of the generally small speaker or speakers in the device. Thus, when there is increased ambient sound such as when the vehicle is moving, it is often difficult for the user to clearly and adequately hear the sound emitted from the personal communication device.

The simplest systems incorporating cradles with sound amplification simply send an electrical signal through a wire attached to an external speaker which is either positioned within the vehicle cabin, or is an integral component of the vehicle's sound system. More frequently the sound is transmitted for amplification to an external speaker via wireless means, such as Bluetooth. The external speakers produce the sound that normally would be emitted from the mobile communication device, but louder. Likewise, some systems, and in particular factory OEM systems in vehicles, use an external in-cabin microphone to pick up sound from the user/driver. The microphone may be positioned on the dashboard or other similar location close to the user, and based on the sounds received an appropriate electrical signal is sent to the personal communication device. The electrical signal can be sent via wired or wireless methods.

Hands free systems such as Bluetooth based systems are now included as standard equipment in some of the newest vehicles, and also in some high-end aftermarket stereo systems. These standard equipment and aftermarket stereo systems often require nothing more than “pairing” of a personal communication device with the system and then the initiation or receipt of a phone call. Such systems often employ a microphone wired within the vehicle cabin to pick-up sound from the user/driver, along with the vehicle's speakers to reproduce the sound that otherwise would be produced by the personal communication device. Unfortunately, the majority of vehicles currently in use support neither wired nor wireless “hands free” systems; additionally both the above-mentioned wired and wireless “hands free” systems are costly. Furthermore, those vehicles that do contain a wireless “hands free” system must include an embedded microphone somewhere within the passenger cabin, either in the stereo unit itself, the steering wheel, or elsewhere. Finally, these Bluetooth based “hands free” systems frequently experience intermittent signal degradation or signal loss, generally annoying the user.

An alternative to a Bluetooth based hands free solution, which affords greater clarity and reliability, is a wired hands free solution that plugs directly into a personal communication device. This may be implemented as a standalone system as in U.S. Pat. No. 6,631,279 to Rivera, or as an integral part of a cradle as in U.S. Pat. No. 5,956,399 to Whitley et al. While these are functional solutions they are also not without limitations. There are currently a large number of different personal communication devices on the market and in use, and they frequently employ different shapes, sizes, and configurations of ports into which a hands-free system may be adapted. This diversity of plug configurations makes it difficult to create a universal plug-in hands free system. Further, integrating a plug in hands free system into a personal communication device cradle presents difficulties in aligning and inserting a plug into the communication device. Finally, a plug in hands free system similar to that of the '279 patent requires the user to insert a speaker into their ear, which can be uncomfortable and annoying, and further to deal with the hassle of having a cord running from their ear to their communication device which can be very inconvenient and distracting.

Another approach to augmenting a mobile device is disclosed in U.S. Pat. No. 5,282,246 to Chao-Ming Yang, and similar devices is disclosed in U.S. Pat. No. 6,510,311 to Stitt. The disclosure of the '246 patent describes two microphones and two loudspeakers to pickup and amplify separately the sound emitted by the speaker of mobile device into the passenger cabin, and the sound from the passenger into the microphone located in the mobile device. The device of the '311 patent utilizes a microphone and speaker to pick-up and relay sound to the microphone of a communication device. This approach overcomes some of the issues present in both wired and wireless hands free devices. There is no signal loss due to interferences with wireless communication, and without a wired connection to the communication device there is no need to account for different plug designs and configurations. However, these devices suffer from problems of potential audio feedback and also from high power consumption as the device does not have an automatic means to power on and off. These two issues make the design of the '246 and '311 patents impractical for use in a modern, small, and mobile vehicle mounted cradle and sound amplifier.

Thus, for many users of personal communication devices, there is not currently a simple and cost effective solution for implementing a hands free system in a vehicle. Often times these users will simply place their personal communication device in hands free mode, or speaker mode, and hold the phone in their hand while they drive and talk. This has become a popular and simple solution and many employ this technique under the assumption that such use is not in violation of anti-hands free laws. Due to the perceived danger involved with driving while holding an electronic device, some users may place their personal communication device in a cup holder or cubby in the dash and speak into the personal communication device's microphone from a distance. When the personal communication device is located in a cup holder or cubby without amplification the user is frequently unable to hear their personal communication device over ambient road or vehicle noise. Furthermore, the phone is generally neither restrained nor easily accessible, thus increasing the risk to the user/driver as the personal communication device may move about the passenger cabin and may be difficult for the user/driver to reach and activate. Clearly a better solution is needed.

Many approaches have been tried for securing a personal communication device, or more generally, personal items, within easy reach of the driver in a vehicle cabin. As mentioned above some solutions employ the cup holders included in most vehicles. Another type of solution utilizes the sun visor located just above and in front of the drivers head. Some of these approaches can be found in U.S. Pat. Nos.: 5,711,469 to Gormley et al, 5,402,924 to Gilson, 3,106,202 to Hunt, and 3,809,428 to Cohen. While these devices are capable of holding personal items or personal communication devices within reach of the user/driver, they were all lacking some of the key advantages of the current invention. None of these prior US patents discloses a holder that is easy to both attach and detach from the sun visor, nor do they disclose a holder that is easy to insert or remove a personal communication device from. Further these prior art do not disclose a holder in which it is easy to use said personal communication device while the vehicle is in motion.

In order to overcome the limitations of conventional hands free devices, it is an objective of the present invention to provide a vehicle mounted cradle and sound amplifier for a personal communication device.

It is a further objective of the present invention to securely hold the personal communication device in a location easily accessible by the user

It is a further objective of the present invention to provide an improved and more reliable means for reproducing sound from the personal communication device than the many wireless means of the prior art, which are subjected to potential Interference.

It is a further objective of the present invention to amplify or retransmit the sound emanating from a personal communication device, and to provide a means for relaying ambient sounds to the personal communication device's microphone.

It is a further objective of the present invention to provide a vehicle mounted cradle and sound amplifier for a personal communication device exhibiting exceptionally long battery life through advanced methods of automatically powering on and powering off the cradle.

Finally, it is a still further objective of the present invention to provide a cradle and sound amplifier for a personal communication device that does not create disrupting and annoying audio feedback loops.

### SUMMARY OF THE INVENTION

The present invention is a hands free, personal communication device (hereinafter “mobile device”) holder and sound broadcaster. The invention comprises a cradle for securely and releasably holding a mobile device, a flat panel speaker for rebroadcasting or amplifying the sound from the mobile device, and a means for directing ambient sounds to the mobile device for transmission therefrom.

In a preferred embodiment, the cradle comprises a microphone placed in close proximity to the speaker on the mobile device, the microphone detecting sounds emitted from the mobile device preferably when the device is in “hands free” mode. The microphone then converts said sounds to an electrical signal that is transmitted to a flat panel speaker, which then reproduces and amplifies said sounds for listening by the user. In an alternative embodiment the cradle further comprises a second microphone for receiving sounds from the environment surrounding the cradle. These ambient sounds are converted to an electrical signal that is sent to a second speaker in close proximity to the microphone on the mobile device. This second speaker may then reproduce and amplify the ambient sounds, which are picked up and transmitted by the mobile device. In an alternative embodiment, the “sound” that would normally be produced by the mobile device is instead transmitted to the cradle as an electrical signal, which in turn converts the signal to a sound wave which in turn is broadcast for the user to hear. Likewise, rather than reproduce ambient sound for detection by the mobile device, the cradle in this alternative embodiment may convert said ambient sound to an electrical signal which is then fed to the mobile device for transmission therefrom.

In the preferred embodiment, the cradle mounts within the cabin of a vehicle, and preferably to a vehicle sun visor for easy access by the user. The cradle comprises a slot for receipt of the mobile phone. The cradle may further comprise a means for conserving power by switching to a standby mode when there is no mobile device inserted or when the mobile device is not in use. In a preferred embodiment the cradle has a footprint approximately the same size as the mobile device.

The device improves upon the prior art in that it exhibits excellent sound quality and volume while minimizing audio feedback, wireless signal loss, and battery loss. Finally, the simplicity of the device increases reliability during its use, decreases the cost of manufacturing, and makes the safety of hands free mobile phone use more greatly accessible to the public.

These and other objects, advantages, features and aspects of the present invention will become apparent as the following description proceeds. To the accomplishment of the foregoing and related ends, the invention, then, comprises the features hereinafter more fully described and particularly pointed out in the claims, the following description and the annexed drawings setting forth in detail certain illustrative embodiments of the invention, these being indicative, however, of but several of the various ways in which the principles of the invention may be employed.

### BRIEF DESCRIPTION OF THE DRAWINGS

In the annexed drawings:

FIG. 1 is a perspective view of the device according to the preferred embodiment of the invention, wherein a mobile device is placed in a cradle on the device;

FIG. 2 is a rear view of the device according to the preferred embodiment of the invention, wherein a mobile device is placed in a cradle on the device;

FIG. 3 is a cut away view from the rear of the device according to the preferred embodiment of the invention, wherein a mobile device is placed in a cradle on the device;

FIG. 4 is perspective view from the rear of the device according to the preferred embodiment of the invention, wherein a mobile device is placed in a cradle on the device;

FIG. 5 is a perspective side view of the device according to the preferred embodiment of the invention;

FIG. 6 is a front view of the device according to the preferred embodiment of the invention wherein a mobile device is placed in the device, and further showing cross sectional cutlines taken along point A-A and B-B;

FIG. 7 is a cross sectional view taken along cutline A-A in FIG. 7;

FIG. 8 is a cross sectional view taken along cutline B-B in FIG. 7; and

FIG. 9 is a perspective view of the device according to a first alternative embodiment wherein a phone is placed in a cradle on the device.

### DETAILED DESCRIPTION OF THE INVENTION

The following description is presented to enable a person of ordinary skill in the art to make and use various aspects and examples of the present invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims.

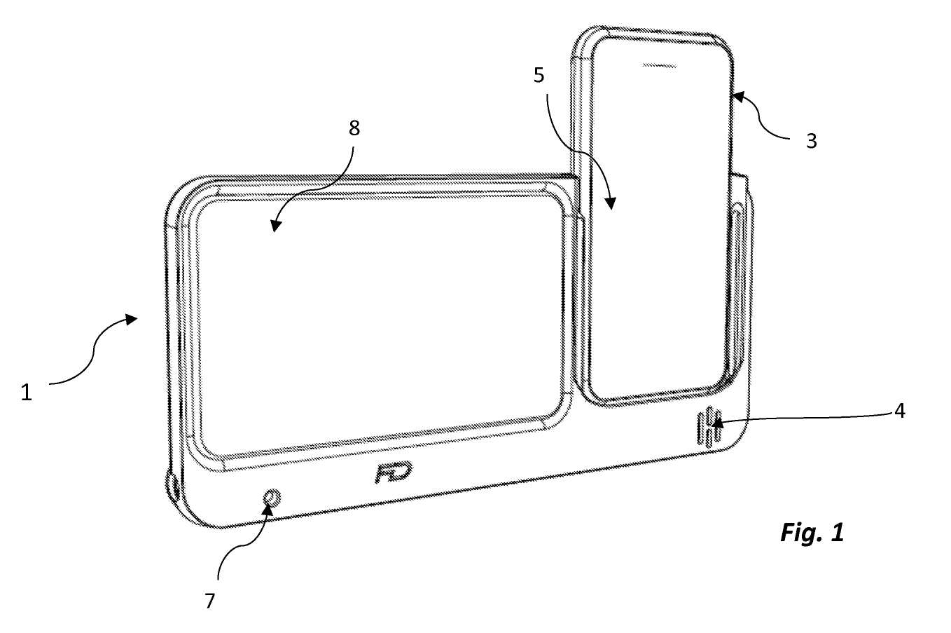

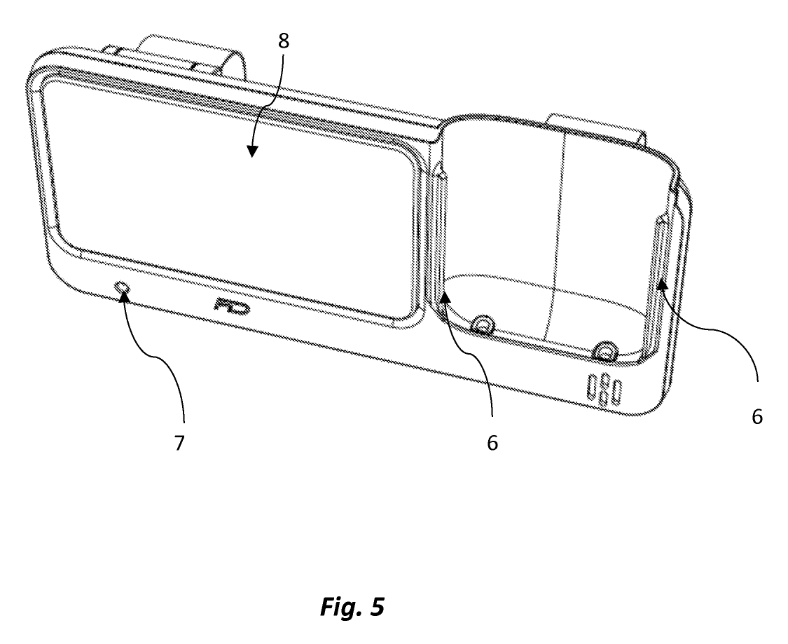

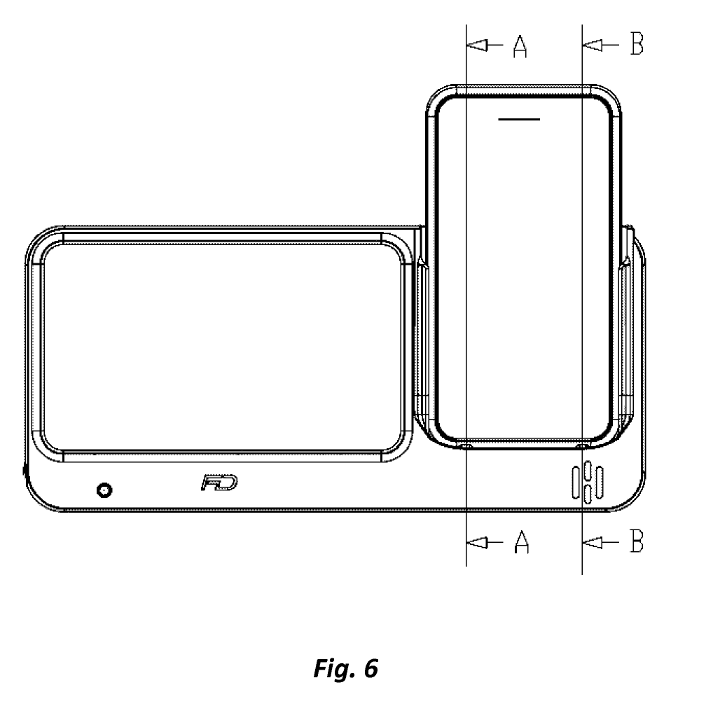

Referring now to the drawings, and specifically to FIG. 1, a preferred exemplary embodiment of the mobile device cradle 1 and associated mobile device 3 is shown. For purposes of this patent application the term “mobile device” shall mean portable communication device, mobile phone, cell phone, and specific models of the same such as the Blackberry or the Apple iPhone® 3G/3GS. In the preferred embodiment a mobile device is depicted that has a control interface 5 facing towards the front of the cradle when the mobile device is inserted. Here, mobile device 3 is shown in insertable relation between two semi-rigid rails 6 (not labeled in this Figure, see FIG. 5).

The semi-rigid rails are preferably made of flexible plastic and are slightly narrower than the width of the mobile device, yet flexible enough as to secure the device with a snug fit. Optionally, the inside lining of the cradle may comprise a rubber-like surface to provide additional grip for the mobile device. This additional grip is useful when the device is used in a vehicle that is accelerating, turning or otherwise subjecting the cradle to external forces. Ridges 6 do not extend upwards the entire length of the communication device, thereby the top portion of the mobile device and any buttons thereon (such as power button or volume adjustment) remain within easy access for the user.

Continuing with FIG. 1, cradle 1 further comprises an LED 7 and a small opening 4. LED 7 optionally signals to the user that the cradle is active or that the portable device is inserted properly. Small opening 4, covered partially by a grill or mesh, provides a path for sound waves to reach the mobile devices microphone.

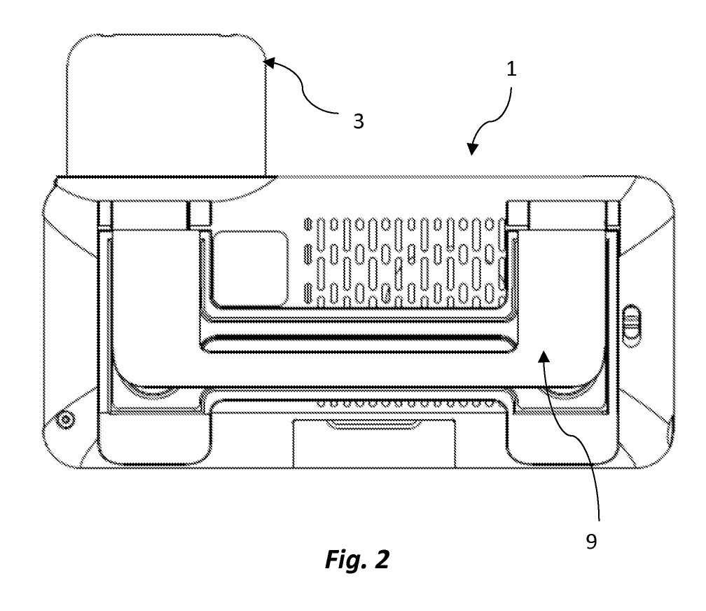

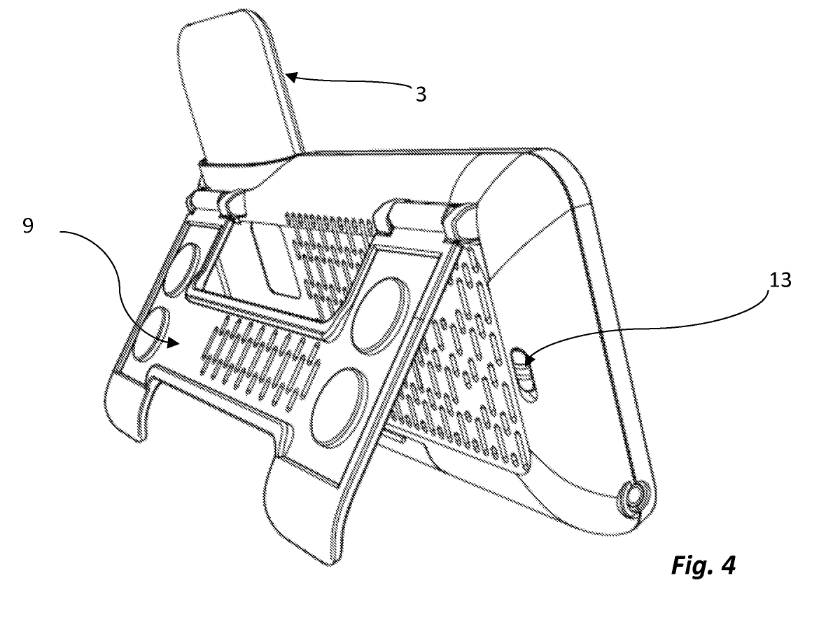

FIG. 2 depicts a rear view of the device where the back face of the mobile device 3 is shown extending above the top most portion of cradle 1. This figure also shows a pop-out stand 9 for use of the device on a flat surface such as a table or desk. Pop-out stand 9 is also shown in FIG. 4.

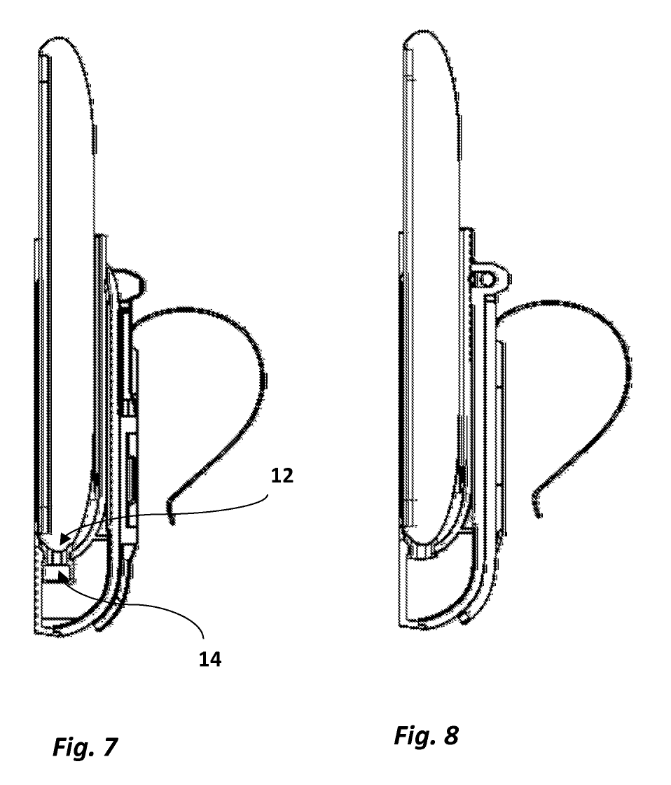

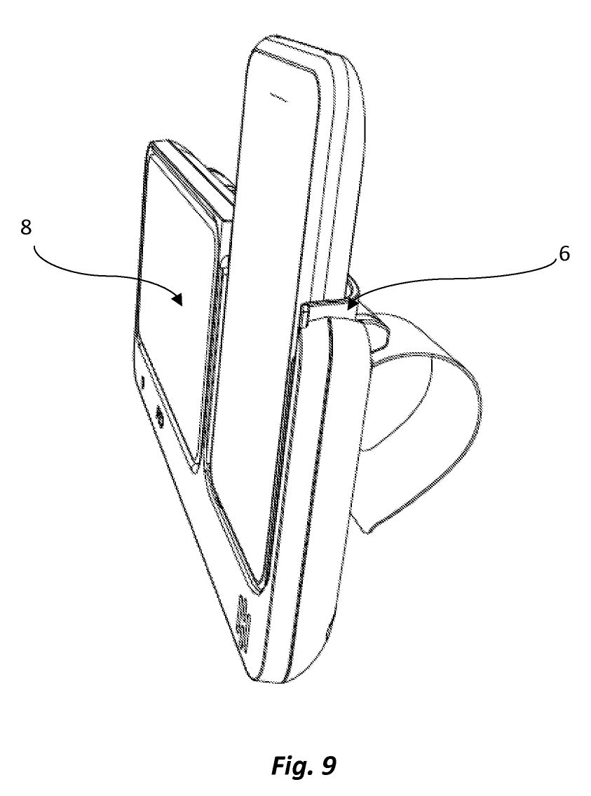

Turning briefly to FIG. 7, within the cradle is shown cradle microphone 14 positioned adjacent to and within close proximity to mobile device micro-speaker 12. Sound captured by cradle microphone 14 is electronically sent to cradle speaker 8 (see FIG. 1), which amplifies the sound, as described in detail further in this document. In an exemplary embodiment the cradle microphone is a unidirectional Electret Condenser Microphone (ECM) biased to reduce power rail droop during audio transients. Two levels of bias are provided. Under normal operation bias is approximately 500 uA (0.5 mA) while in standby operation bias is approximately 50 uA. While a bias of only 50 uA would not be adequate under normal operation, it is adequate for its purpose here which is to detect a threshold level of audio from the mobile device micro-speaker and then switch, within less than about 1 ms, to normal operation with about 500 uA bias. Accordingly, when the mobile device is not outputting any sound, the system runs at a lower level than when the mobile device is outputting sound.

The sound captured by the cradle microphone 14 is output as an electrical signal that is then high pass filtered with left and right channels summed so that a resulting mono signal may then be fed to the inverting input of a low power comparator. The non-inverting input is held at about 5-15 mV above ground (0V). When the audio input signal level on the inverting input exceeds this set level (5-15 mV above ground) then the output is supplied to a cradle speaker 8.

Cradle speaker 8 amplifies the output using in an exemplary embodiment a Class G amplifier such as the MAX 9730 from Maxim Integrated Products out of Sunnyvale, Calif. The amplifier drives a standard 8-ohm exciter (such as part JM-ET-1191733305-08K4F05 available by NXT out of Cambridge, United Kingdom), which drives cradle speaker 7.

In an exemplary and preferred embodiment cradle speaker 8 is a small (approximately 4.5 in x 2.5 in) PVC covered balsa wood panel, which creates a flat panel or distributed mode loudspeaker (DML). Speaker 8 preferably outputs the sound at a volume level greater than the volume level capable of being output by the mobile device. DML is preferred because it substantially reduces or eliminates feedback during use, despite the close proximity of up to two speakers and two microphones as described herein. This improved resistance to microphone feedback is due to the fact that the sound emitted from a typical flat panel speaker is highly de-correlated unlike a conventional pistonic cone loudspeaker, which typically generates a coherent pattern of sound more likely to elicit feedback from a nearby microphone.

Cradle 1 may optionally comprise an input for a 3.5 mm audio jack or other inputs for providing direct electrical connections to mobile devices. In these embodiments the cradle does not monitor sound waves to determine whether a threshold level is reached for activation, but instead monitors the digital signal received directly through the input. The unit may remain in stand-by mode until a threshold electrical signal is detected. When a signal is detected the cradle speaker may convert said signal to audio for transmission therefrom.

Because in a preferred embodiment the system amplifies the sound waves generated by the mobile device, volume adjustments on the mobile device will correlate to volume adjustments of speaker 8. Hence, if the volume of the mobile device is increased, the volume of speaker 8 will similarly be increased. This is because in the preferred embodiment the cradle captures sound from the mobile device micro-speaker and amplifies it a set amount. In an alternative embodiment the device detects the level of ambient sound and the cradle automatically amplifies the mobile device sound to a greater extent when said ambient sound is high. For instance, when a vehicle begins moving at highway speeds, the additional ambient sound (tire noise, wind noise) will increase and the cradle will automatically boost the sound volume to a higher level. When ambient sound is low again, the sound boosting is reduced. Alternatively, the cradle may have volume controls independent of the mobile device for user adjustment.

Cradle microphone 14 is positioned close to mobile device micro-speaker 12 and is well insulated from ambient external noise. This positioning minimizes ambient external noise (road noise, the user talking) from being mistakenly amplified by the cradle and output through cradle speaker 8, which in the preferred embodiment outputs only sound originating from the mobile device. In a less preferred embodiment cradle speaker 8 amplifies sound substantially only from the mobile device. To these ends, in a preferred embodiment, soft foam rubber-like material surrounds the cradle microphone such that when the communication device 3 is inserted in the cradle, the material conforms slightly the shape of the device, thereby creating a light seal around it and insulating it from the entry of unwanted sound.

Once inserted, the mobile device microphone may in a preferred embodiment functions normally. The user speaks, and sound waves travel through small opening 4 and reach the mobile device microphone. In an additional exemplary embodiment of the invention, an inverted cone directed outwards away from the center of the cradle serves to direct sound waves to the mobile device microphone. This may be a targeted system to further prevent unwanted ambient noise from being transmitted by the mobile device. The inverted cone may be flush with an outer surface of the cradle, or may be a protuberance on the outer surface.

FIG. 4 best shows optional pop-out stand 9 as well as cradle on/off switch 13. Given the power-saving components of the invention, the on/off switch is generally not needed other than for example during air travel or during long periods of storage.

In an alternative embodiment of the invention, the cradle 1 comprises a lower slot at its bottom base proximate to the microphone. Many mobile devices may optionally receive power through a power cord that inserts to the mobile device at its base. For these devices, the power cord may be threaded through the lower slot. A locking mechanism may be utilized to more tightly secure the cord after it is threaded through the lower slot, easing the connection of the power cord to the mobile device after it is inserted. In this embodiment, the mobile device may be charged and powered up while in use. This configuration is applicable whether the cradle is mounted in a vehicle or not.

In a second alternative embodiment of the invention (not shown), once inserted, the mobile device microphone is located in proximity to a second cradle speaker. This second cradle speaker is attached to a second cradle microphone. This second cradle microphone is positioned in a location and manner such that it will pick-up vocalizations from the user of the device and relay them to the second cradle speaker and thus facilitate the mobile device in picking-up the vocalizations of the user. Similarly to the first speaker and microphone configuration, in this embodiment the mobile device microphone is well insulated from outside ambient noise.

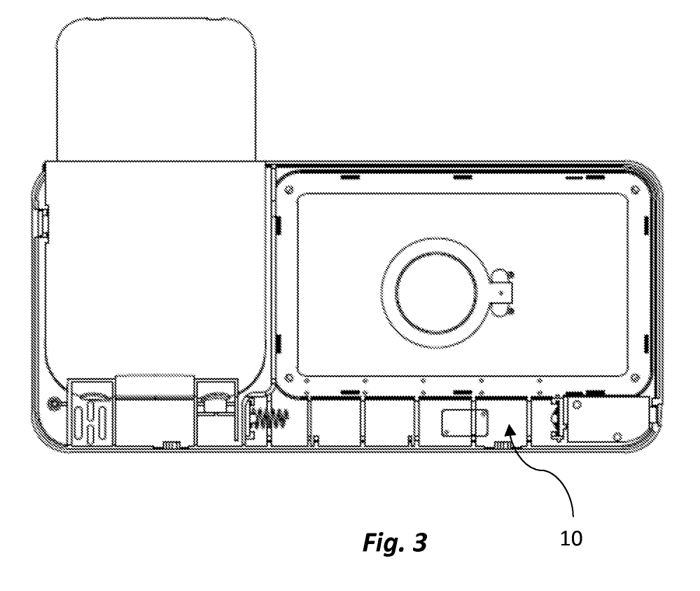

Preferably, batteries power the cradle and in an exemplary embodiment shown in FIG. 3 a battery compartment 10 is depicted. In this exemplary embodiment, AAA batteries (not shown) power the cradle, although this may be readily adjusted in order to modify battery life and overall weight and size of the cradle. Additionally, the cradle may optionally accept DC or AC from an external power supply.

As the primary power saving means, the cradle microphone remains in a sleep state while not in use. In this embodiment, power is only supplied when sound is detected and likewise power is cut when over a set period of time sound is not detected. Very little to no current is drawn while the device is in sleep mode. In an exemplary embodiment the overall current in sleep mode is about 60-70 uA, thus extending the life of 2 AAA batteries (3V at 1250 mA Hour) to approximately 2 years of standby operation with the cradle microphone readily monitoring audio input for the wake up threshold.

Although potentially any sound may wake-up the system from sleep mode, due to the above-mentioned insulating means and other means for ensuring that the cradle microphone receives substantially no sound but for that sound emitted by personal device 3, it is highly unlikely that the device will leave sleep mode except when there is a mobile device inserted into the device and the mobile device is actively delivering sound via its speaker.

Resistors and capacitors could be preferably selected so as to give a time constant that must be met before power will be supplied or cut. For instance, if sound is not detected for ten seconds or longer, power to the cradle may be cut or decreased so as to further extend battery life. Accordingly, the auto on-off circuit section serves to preserve battery life when no audio signal is present, automatically turn on the unit when audio signals are present, and keep the unit on during gaps or quiet periods in the music, if the cradle is being used to amplify music from the personal device. It will be understood that the invention is not limited to the exemplary times and values given above as these times and values may greatly vary.

It is these power saving features of the cradle that allow operation for extended periods of time on only AAA batteries. In an additional alternative embodiment, the cradle remains in the off position so long as an actuator (not shown in the Figures) located at the bottom of the cradle is not depressed. Once a mobile device 3 or other object is inserted in the cradle, however, the actuator is depressed and the device powers on. This feature saves power and eliminates the possibility that the user will inadvertently forget to turn the device off. Optionally, a small LED 7, also activated by the presence of the mobile device 3 in the cradle may activate to alert the user that the system is powered on. Alternatively, other lighting means may be employed, such as a light pipe, lighting the perimeter of the speaker, or the like.

As an additional alternative, a combination of the above two power saving techniques may be employed. For instance, the cradle may be completely powered down and drawing no current until the actuator is depressed by the presence of the mobile device 3. Then, once depressed, the sound dependent power saving technique may be used. In this combination, the power savings and extension of battery life would be the greatest, however, simplicity and low cost of the invention is somewhat compromised.

In use, the user of the cradle in a preferred embodiment merely inserts the personal communication device 3 into the cradle between the semi-rigid rails 6. The user then ensures the mobile device is in hands free or speaker mode, and speaks normally. The mobile device 3 used in the present invention includes its own microphone as all mobile devices do and this still functions normally. In every embodiment, cradle microphone 11 monitors and accepts as input sound emitted from the mobile device micro-speaker, where it is amplified and projected through speaker 8. In an exemplary use, the entire cradle is releasably attached to a sun visor of a vehicle so that control interface 5 is facing the driver's seat of the vehicle for easy use while the seat is occupied. The device may also be attached via a magnetic or other attachment means to a flexible arm attached to the inside of the windshield of a vehicle.

Although the present description focuses on reproducing sound coming from a voice in a telephone call on a mobile device, the typical mobile device more frequently includes other features, such as music playback, books on tape, podcasts etc. The present invention does not distinguish what sounds are being reproduced, and music playback or any other sound emitted from the mobile device micro-speaker may be accurately reproduced. Further, because transmitting music via Bluetooth can often result in degradation in quality of the music, the present device generally offers an improvement in quality over Bluetooth.

The cradle may be attached to or adapted to other components in a vehicle as well, such as cup holders, dashboard, doors, center console, and the like. Additionally, pop-out stand 9 similar to that in a picture frame allows the cradle to rest on a desk or other flat surface.

Although in the embodiments shown in the attached drawings, the communication device 3 is shown on the right and the flat panel speaker 8 is shown on the left, these components may be switched without departing from the spirit of the invention.

While the invention has been described in connection with specific embodiments thereof, it will be understood that it is capable of further modifications and this application is intended to cover any variations, uses, or alterations of the invention. In general, the principles of the invention and including such departures from the present disclosure as come within known or customary practice within the art to which the invention pertains and as may be applied to the essential features hereinbefore set forth and as follows in the scope of the appended claims.

Therefore, the foregoing is considered as illustrative only of the principles of the invention. Further, since numerous modifications and changes will readily occur to those skilled in the art, it is not desired to limit the invention to the exact disclosure shown and described, and accordingly, all suitable modifications and equivalents may be resorted to, falling within the scope of the invention.

I claim:

1. A vehicle mounted cradle and sound amplifier for a personal communication device comprising:
a. a cradle for holding said personal communication device with a control interface;
b. a mounting means to secure said cradle within a passenger cabin of a vehicle;
c. an amplifying means comprising a microphone and a speaker, said amplifying means amplifying sounds from said personal communication device;
d. a channel for directing sound from said passenger cabin to said microphone;
e. a power source; and
f. a power saving means for regulating power from said power source, the power saving means comprising an audio-level based lower-power standby-mode.

2. The vehicle mounted cradle and sound amplifier according to claim 1 wherein said cradle is configured such that said control interface faces towards a driver's seat located in said vehicle.

3. The vehicle mounted cradle and sound amplifier according to claim 1 wherein said cradle further comprises semi-rigid rails configured to securely retain said personal communication device.

4. The vehicle mounted cradle and sound amplifier according to claim 3 wherein said cradle is configured such that said control interface faces towards a driver's seat located in said vehicle.

5. The vehicle mounted cradle and sound amplifier according to claim 1 wherein said mounting means comprises a tensioned clip configured to securely attach to a sun visor in said vehicle.

6. The vehicle mounted cradle and sound amplifier according to claim 5 wherein said microphone is located in said cradle in close proximity to said personal communication device wherein said personal communication device is removably inserted into said cradle.

7. The vehicle mounted cradle and sound amplifier according to claim 6 wherein said first microphone is substantially isolated from sounds not originating from said personal communication device.

8. The vehicle mounted cradle and sound amplifier according to claim 7 wherein said cradle means is configured such that said control interface faces towards a driver's seat located in said vehicle.

9. A vehicle mounted cradle and sound amplifier for a personal communication device comprising:
a. a cradle for holding said personal communication device with a control interface;
b. a mounting means to secure said cradle within a passenger cabin of a vehicle;
c. a first amplifying means comprising a first microphone and a first speaker, said first amplifying means amplifying sounds from said personal communication device;
d. a second amplifying means comprising a second microphone and a second speaker, said second amplifying means amplifying sounds from said vehicle;
e. a power source; and
f. a power saving means comprising a low power standby-mode for regulating power from said power source.

10. The vehicle mounted cradle and sound amplifier according to claim 9 wherein said power saving means is audio level-based.

11. The vehicle mounted cradle and sound amplifier according to claim 10 wherein said cradle is configured such that said control interface faces towards a driver's seat located in said vehicle.

12. The vehicle mounted cradle and sound amplifier according to claim 9 wherein said mounting means comprises a tensioned clip configured to securely attach to a sun visor in said vehicle.

13. The vehicle mounted cradle and sound amplifier according to claim 12 wherein said cradle is configured such that said control interface faces towards a driver's seat located in said vehicle.

14. The vehicle mounted cradle and sound amplifier according to claim 9 wherein said first microphone is located in said cradle in close proximity to said personal communication device wherein said personal communication device is removably inserted into said cradle.

15. The vehicle mounted cradle and sound amplifier according to claim 14 wherein said first microphone is substantially isolated from sounds not originating from said personal communication device.

16. The vehicle mounted cradle and sound amplifier according to claim 15 wherein said cradle means is configured such that said control interface faces towards a driver's seat located in said vehicle.

17. A vehicle mounted cradle and sound amplifier for a personal communication device comprising:
a. a cradle for securing a personal communication device, said cradle mounted within the passenger cabin of a vehicle and further comprising:
i. a microphone;
ii. an amplifier; and
iii. a flat panel speaker;
b. a personal communication device comprising a control interface, the personal communication device secured to said cradle and oriented such that said control interface faces towards a driver's seat located in said vehicle;
c. a channel for directing sound from said passenger cabin to said microphone;
d. a power source; and
e. a power saving means for regulating power from said power source, the power saving means comprising an audio-level based lower-power standby-mode.

18. The vehicle mounted cradle and sound amplifier according to claim 17 wherein said mounting means comprises a tensioned clip configured to securely attach to a sun visor in said vehicle.

19. The vehicle mounted cradle and sound amplifier according to claim 18 wherein said first microphone is located in said cradle in close proximity to said personal communication device when said personal communication device is removably inserted into said cradle.

20. The vehicle mounted cradle and sound amplifier according to claim 19 wherein said first microphone is substantially isolated from sounds not originating from said personal communication device.
